(19) United States
(12) Patent Application Publication
(10) Pub. No.: US 2024/0326617 A1
(43) Pub. Date: Oct. 3, 2024

(54) CHARGING SOCKET FOR ELECTRIC VEHICLE AND ELECTRIC VEHICLE

(71) Applicant: PEGATRON CORPORATION, Taipei City (TW)

(72) Inventor: Chien-Min HUANG, Taipei City (TW)

(21) Appl. No.: 18/408,168

(22) Filed: Jan. 9, 2024

(30) Foreign Application Priority Data
Mar. 31, 2023 (TW) 112112634

(51) Int. Cl. B60L 53/16; H01R 13/11; H01R 13/73; H01R 35/00

(52) U.S. Cl. CPC B60L 53/16; H01R 13/111; H01R 13/73; H01R 35/00; H01R 2201/26

(57) ABSTRACT

The present invention discloses a charging socket for an electric vehicle and an electric vehicle. The electric vehicle includes a vehicle body, and the vehicle body includes an interior and an exterior opposite to the interior. The charging socket includes a base and a first charging slot, the base is connected to the vehicle body and includes a first surface facing the interior, and the first charging slot is arranged on the first surface of the base and is exposed in the interior of the vehicle body.

### CROSS REFERENCE TO RELATED APPLICATIONS

This application claims the priority benefit of Taiwan applications serial no. 112112634, filed on Mar. 31, 2023. The entirety of the above-mentioned patent application is hereby incorporated by reference herein and made a part of this specification.

### BACKGROUND

### Technical Field

The present invention relates to a charging socket, and in particular, to a charging socket arranged on an electric vehicle and an electric vehicle.

### Description of Related Art

Climate change is closely related to global warming, while global warming and energy depletion are the most severe crises faced by humankind in the 21st century. Warming actually has a great impact on animals and plants. However, since the Industrial Revolution in the 19th century, humans have relied too much on burning fossil fuels such as petroleum and emitted a large amount of carbon dioxide, which has intensified the warming and affected the survival of animals and plants on the earth. To reduce the impact of carbon dioxide on climate change, switching to electric vehicles and reducing carbon footprint generated in a vehicle production process will be essential for carbon reduction.

An electric vehicle relies on electric energy to drive a motor to generate power, and needs to be charged when battery power is insufficient. However, the source of power relies on charging facilities (for example, a charging pile). If there are no charging facilities available nearby when the electric vehicle needs to be charged, the electric vehicle may not be able to move. Therefore, setting up of charging facilities has always been one of the most critical issues to be resolved in the promotion of electric vehicles.

To charge an electric vehicle anytime and anywhere, a start-up company has launched a portable charger that can charge the electric vehicle. The portable charger is slightly larger than a carry-on suitcase and comes with wheels for easy movement. The point of the portable charger is that the charger can be used wherever a vehicle can be parked, and the charger can be placed in the vehicle when not in use and is placed outside the vehicle to be connected to a charging socket only during charging. Therefore, the charger can be used anywhere and anytime, thereby improving autonomy and convenience of charging. The portable charger claims to provide up to 20 miles to 40 miles of range (depending on a capacity and the vehicle), which is enough to satisfy daily needs and ordinary commuting needs, and provides a charging status update through control of a mobile phone APP.

However, convenient as the combination of software and hardware seems, the portable charger needs to be placed outside the vehicle (on the ground) in use, giving rise to some risks or problems. For example, during charging, the charger is exposed to the risk of being damaged or stolen if left unattended. In addition, when there is insufficient space in an external environment, arbitrary placement of the charger may affect the safety of other road users. In addition, in case of a bad weather condition such as extremely heavy rain, snow, thunder, strong wind, or sand and dust, the charger is not safe to use.

### SUMMARY

In view of the foregoing subject, an objective of the present invention is to provide a charging socket for an electric vehicle and an electric vehicle, which can avoid the foregoing risks or problems.

To achieve the foregoing objective, the present invention provides a charging socket for an electric vehicle. The electric vehicle includes a vehicle body, and the vehicle body includes an interior and an exterior opposite to the interior. The charging socket includes a base and a first charging slot, the base is connected to the vehicle body and includes a first surface facing the interior, and the first charging slot is arranged on the first surface of the base and is exposed in the interior of the vehicle body.

To achieve the foregoing objective, the present invention further provides an electric vehicle, including a vehicle body and a charging socket. The vehicle body includes an interior and an exterior opposite to the interior. The charging socket includes a base and a first charging slot, the base is connected to the vehicle body and includes a first surface facing the interior of the vehicle body, and the first charging slot is arranged on the first surface of the base and is exposed in the interior of the vehicle body.

In an embodiment, the charging socket further includes a second charging slot, the base further includes a second surface facing the exterior of the vehicle body, and the second charging slot is arranged on the second surface of the base and is exposed in the exterior of the vehicle body.

In an embodiment, the first charging slot and the second charging slot are symmetrically arranged.

In an embodiment, the charging socket further includes a rotating shaft, the rotating shaft is connected to the base, and the base is adapted to be connected to the vehicle body by the rotating shaft and rotate relative to the vehicle body between a first angle and a second angle.

In an embodiment, at the first angle, the first surface of the base and the first charging slot face the interior of the vehicle body; and at the second angle, the first surface of the base and the first charging slot face the exterior of the vehicle body.

In an embodiment, the charging socket further includes a driving mechanism connected to the rotating shaft, and the driving mechanism is adapted to drive the rotating shaft to rotate, thereby driving the base to rotate between the first angle and the second angle.

In an embodiment, a transverse plane perpendicular to the first surface is defined at the base, and the rotating shaft is substantially perpendicular to the transverse plane.

In summary, in the charging socket for an electric vehicle and the electric vehicle according to the present invention, through a structural design that the base of the charging socket is connected to the vehicle body of the electric vehicle and includes the first surface facing the interior of the vehicle body, and the first charging slot is arranged on the first surface of the base and is exposed in the interior of the vehicle body, the charging socket for an electric vehicle and the electric vehicle according to the present invention can avoid (resolve) various risks caused when a portable charger is placed outside the electric vehicle, for example, problems such as proneness to damage or stealing, an impact on safety of road users, and unsafe use under an adverse weather condition.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1A and FIG. 2A are respectively schematic diagrams of an electric vehicle at different viewing angles according to an embodiment of the present invention:

FIG. 1B is a partially enlarged view of FIG. 1A:

FIG. 2B is a partially enlarged view of a charging socket for an electric vehicle and a charging connector in FIG. 2A:

FIG. 3A and FIG. 3B are respectively schematic diagrams of a charging socket according to an embodiment of the present invention:

FIG. 4 is a schematic cross-sectional view of a charging socket connected to a vehicle body of an electric vehicle according to an embodiment of the present invention; and

FIG. 5A and FIG. 5B are respectively schematic diagrams of a charging socket at different viewing angles according to another embodiment of the present invention.

### DETAILED DESCRIPTION

A charging socket for an electric vehicle and an electric vehicle according to some embodiments of the present invention are described below with reference to related drawings, and same components are described by using same reference signs. The components appearing in the following embodiments are intended to merely describe a relative relationship thereof, and do not represent proportions or sizes of real components.

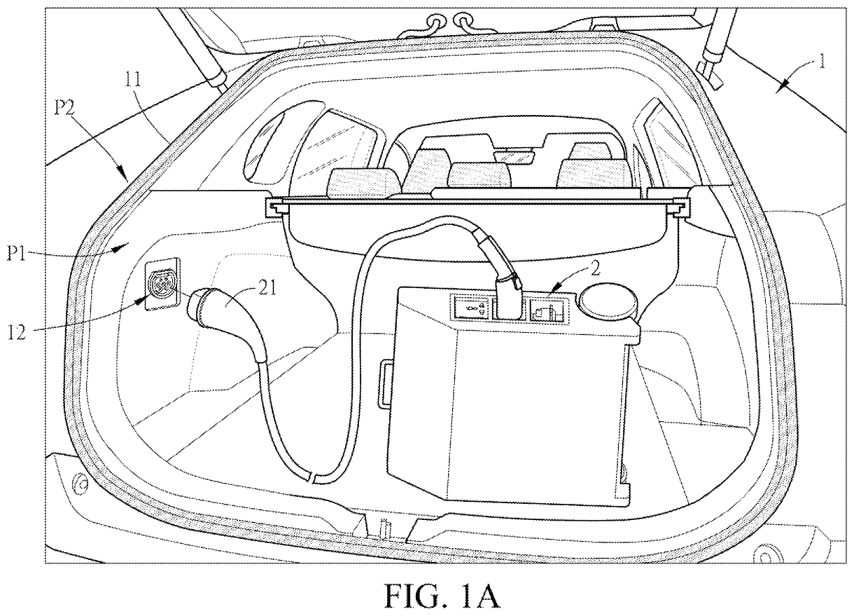

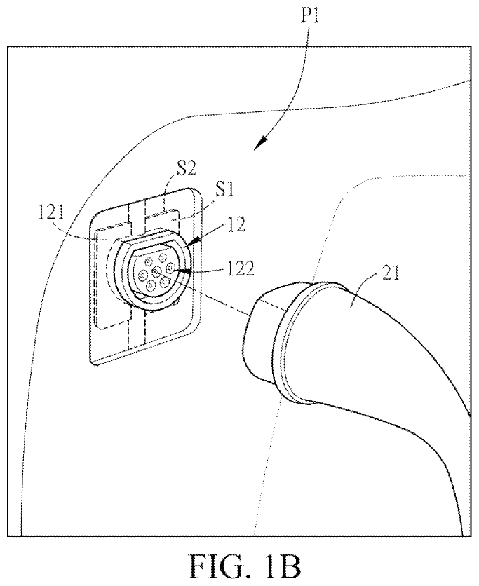

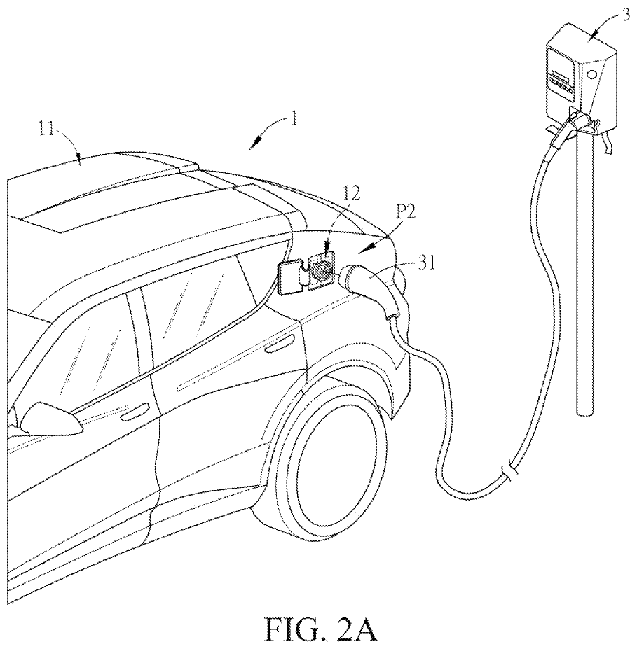

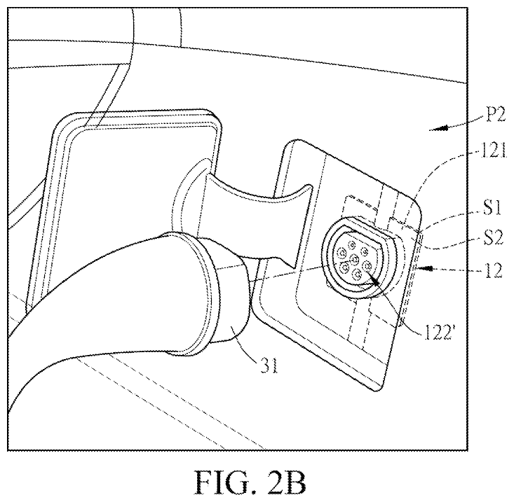

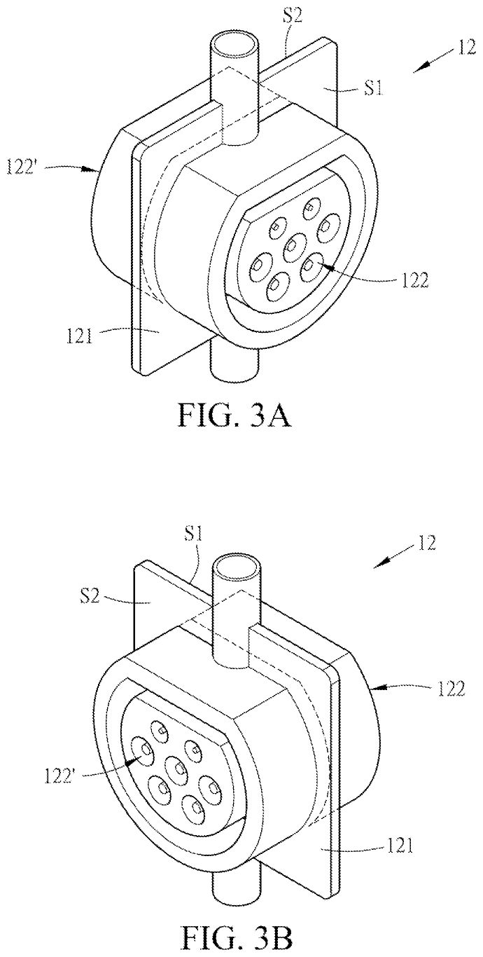

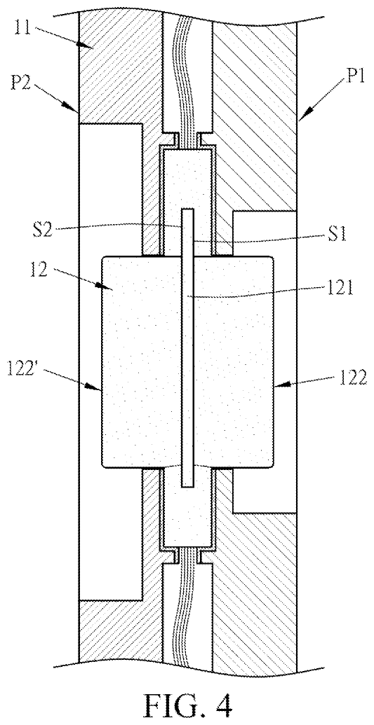

FIG. 1A and FIG. 2A are respectively schematic diagrams of an electric vehicle at different viewing angles according to an embodiment of the present invention, FIG. 1B is a partially enlarged view of FIG. 1A, FIG. 2B is a partially enlarged view of a charging socket for an electric vehicle and a charging connector in FIG. 2A, FIG. 3A and FIG. 3B are respectively schematic diagrams of a charging socket according to an embodiment of the present invention, and FIG. 4 is a schematic cross-sectional view of a charging socket connected to a vehicle body of an electric vehicle according to an embodiment of the present invention. For example, an electric vehicle 1 shown in FIG. 1A and FIG. 2A is an electric sport utility vehicle (SUV), but is not limited thereto. In a different embodiment, the electric vehicle 1 may be an electric sedan, an electric pick-up, an electric bus, or another mobile vehicle driven by electric energy. In addition, for example, the electric vehicle 1 shown in FIG. 1A has an open trunk door.

As shown in FIG. 1A to FIG. 4, the electric vehicle 1 includes a vehicle body 11 and a charging socket 12.

The vehicle body 11 may include an interior P1 and an exterior P2 opposite to the interior P1, and the charging socket 12 is arranged on the vehicle body 11. To be specific, the charging socket 12 is arranged on the vehicle body 11 of the electric vehicle 1, and is configured to provide a charging interface when the electric vehicle 1 is charged. When a charging device, for example, a charging connector 21 of a portable charger 2 in FIG. 1A or a charging connector 31 of a charging pile 3 in FIG. 2A, is inserted into the charging socket 12, the electric vehicle I can be charged. In some embodiments, the charging socket 12 may be arranged on a side surface, a vehicle front, or a vehicle rear of the vehicle body 11, which depends on a use, a vehicle model, or a type of the electric vehicle 1. For example, the charging socket 12 in this embodiment is arranged on the side surface of the vehicle body 11 and is located in a trunk.

The charging socket 12 may include a base 121 and a first charging slot 122. The base 121 is connected to the vehicle body 11 and includes a first surface S1 facing the interior P1 of the vehicle body 11 and a second surface S2 facing the exterior P2 of the vehicle body 11. The first surface S1 and the second surface S2 are opposite surfaces of the base 121. The base 121 in this embodiment is connected to the side surface (which may be referred to as a vehicle side for short) of the vehicle body 11, while the first surface S1 of the base 121 faces the trunk. In other words, the first surface S1 of the base 121 faces the interior P1 (space of trunk is the interior P1 of the vehicle body 11) of the vehicle body 11.

In addition, the charging socket 12 in this embodiment further includes a second charging slot 122′. As shown in FIG. 3A and FIG. 3B, the first charging slot 122 is arranged on the first surface S1 of the base 121 and is exposed in the interior P1 (that is, exposed in the trunk, as shown in FIG. 1A and FIG. 1B) of the vehicle body 11, while the second charging slot 122′ is arranged on the second surface S2 of the base 121 and is exposed in the exterior P2 (as shown in FIG. 2A and FIG. 2B) of the vehicle body 11. In this way, the first charging slot 122 and the second charging slot 122′ are symmetrically arranged on the base 121. Therefore, the charging socket 12 in this embodiment is a charging socket with double surfaces and double slots.

As shown in FIG. 2A, when the electric vehicle 1 is to be charged by using the external charging pile 3, charging can be performed as long as the charging connector 31 of the charging pile 3 is inserted into the second charging slot 122′ of the charging socket 12. As shown in FIG. 1A, when the electric vehicle 1 is to be charged by using the portable charger 2, charging can be performed as long as the portable charger 2 is placed in the trunk of the electric vehicle 1 and the charging connector 21 thereof is inserted into the first charging slot 122 of the charging socket 12. Because the portable charger 2 is placed in the electric vehicle 1, the trunk may be closed during charging, there is no need for supervision, and a driver can feel free to leave to deal with other matters. In addition, the charger does not affect other road users, and there is no need to worry about a problem of a bad weather condition. Therefore, the risks or problems mentioned in the prior art can be avoided (resolved).

In some embodiments, the foregoing first charging slot 122 and the second charging slot 122′ may include a plurality of jacks in response to different charging connectors, and a quantity of the jacks is not limited. If an SAE J1772 charging connector is used as an example, the first charging slot 122 and the second charging slot 122′ may each include five jacks; and if a GB 20234.2 charging connector or an IEC 62196-2 charging connector is used as an example, the first charging slot 122 and the second charging slot 122′ may each include seven jacks. In some embodiments, a cover may be arranged in the interior P1 or the exterior P2 of the vehicle body 11 to cover the first charging slot 122 or the second charging slot 122′, and it is only necessary to open the cover to connect the charging connector when charging is required. Definitely, the cover may be not required for the interior P1 of the vehicle body 11.

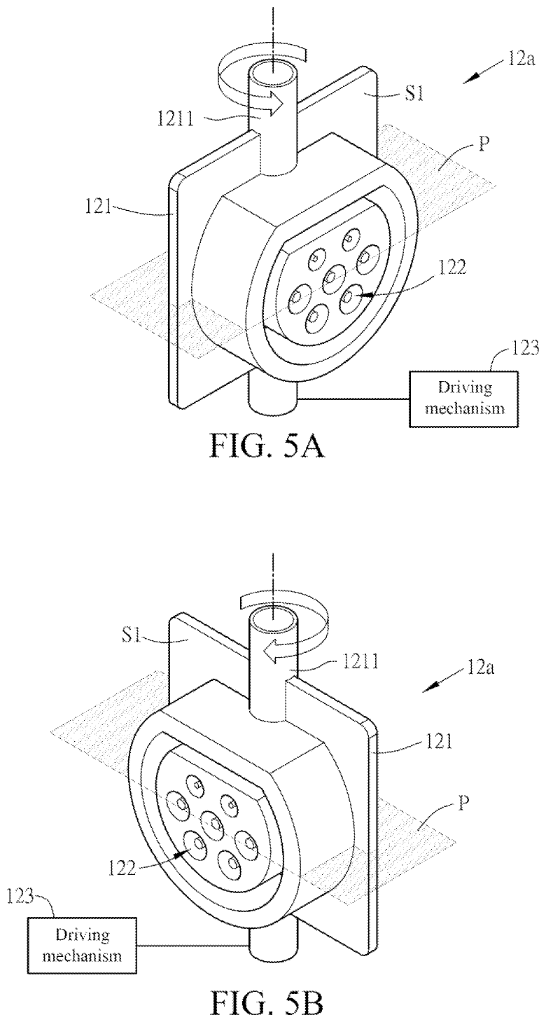

FIG. 5A and FIG. 5B are respectively schematic diagrams of a charging socket at different viewing angles according to another embodiment of the present invention.

A main difference from the charging socket 12 in the foregoing embodiment is that a charging socket 12a in this embodiment is a charging socket with a single side and a single slot, that is, there is only one charging slot (a first charging slot 122). Specifically, a first surface S1 of the charging socket 12a in FIG. 5A may face, for example, an interior of a vehicle body 11, while the first surface S1 of the charging socket 12a in FIG. 5B may face, for example, an exterior of the vehicle body 11. To perform charging in both the interior and the exterior of the vehicle body 11 by using the same first charging slot 122 of the charging socket 12a, the charging socket 12a in this embodiment may further include a rotating shaft 1211 connected to a base 121 (where a connection manner is not limited), and the base 121 is adapted to be connected to the vehicle body 11 by the rotating shaft 1211 and rotate relative to the vehicle body 11 between a first angle and a second angle. The first angle and the second angle are different, and a difference between the first angle and the second angle may be, for example, 180 degrees. In other words, the base 121 may rotate between the first angle and the second angle with the rotating shaft 1211 as an axial center. When the base 121 rotates to the first angle through the rotating shaft 1211 relative to the vehicle body 11 (as shown in FIG. 5A), the first surface S1 of the base 121 and the first charging slot 122 may face the interior of the vehicle body 11; and when the base 121 rotates to the second angle through the rotating shaft 1211 relative to the vehicle body 11 (as shown in FIG. 5B), the first surface S1 of the base 121 and the first charging slot 122 may face the exterior of the vehicle body 11. In this way, charging can be performed in the interior or exterior of the vehicle body 11 by using the first charging slot 122 of the same charging socket 12a.

To achieve a rotating function, the charging socket 12a in this embodiment may further include a driving mechanism 123. The driving mechanism 123 is connected to the rotating shaft 1211 (where a connection manner is not limited), and the driving mechanism 123 is adapted to drive the rotating shaft 1211 to rotate, thereby driving the base 121 (and the first charging slot 122) to rotate between the first angle and the second angle, so that the first charging slot 122 may face the interior of the vehicle body 11 or the exterior of the vehicle body 11, which depends on a charging requirement of a user. In some embodiments, the driving mechanism 123 may include, for example, a motor, a gear, and/or another component that can drive the rotating shaft 1211 to rotate, which is not limited in the present invention.

In some embodiments, the driving mechanism 123 may receive a control command to control the rotating shaft 1211 to rotate, so that the base 121 is rotated to the first angle and the first surface S1 faces the interior of the vehicle body 11, thereby causing the first charging slot 122 to be exposed in the interior (for charging in the interior) of the vehicle body 11, or the base 121 is rotated to the second angle and the first surface S1 faces the exterior of the vehicle body 11, thereby causing the first charging slot 122 to be exposed in the exterior (for charging in the exterior) of the vehicle body 11. The control command may come from an application program (for example, an app) installed on, for example, an electronic device, or come from a physical or virtual key arranged on the electric vehicle 1, which is not limited in the present invention.

It is worth mentioning that a transverse plane P may be defined at the base 121 in this embodiment, the transverse plane P is substantially perpendicular to the first surface S1 of the base 121, and the rotating shaft 1211 of the base 121 is substantially perpendicular to the transverse plane P. The rotating shaft 1211 is a vertical axis of the base 121. When the base 121 rotates from the first angle to the second angle with the rotating shaft 1211 as the axial center, the first charging slot 122 is not to be turned upside down, so that the charging connector of the charging device does not need to be arranged upside down for insertion. Therefore, the charging socket 12a in this embodiment further has a fool-proof mechanism. In some embodiments, the transverse plane P of the base 121 may be substantially parallel to the ground.

In summary, in the charging socket and the electric vehicle according to the present invention, through a structural design of the foregoing embodiments, various risks caused when a portable charger is placed outside the electric vehicle, for example, problems such as proneness to damage or stealing, an impact on safety of road users, and unsafe use under an adverse weather condition, can be avoided (resolved).

The foregoing is merely examples, and is not intended to become a limitation.

Any equivalent modification or change made to the present invention without departing from the spirit and scope of the present invention should fall within the appended claims of the application.

What is claimed is:

1. A charging socket for an electric vehicle, wherein the electric vehicle comprises a vehicle body, the vehicle body comprises an interior and an exterior opposite to the interior, and the charging socket comprises:
a base, connected to the vehicle body, and comprising a first surface facing the interior; and
a first charging slot, arranged on the first surface of the base, and exposed in the interior of the vehicle body.

2. The charging socket according to claim 1, further comprising:
a second charging slot, wherein the base further comprises a second surface facing the exterior of the vehicle body, and the second charging slot is arranged on the second surface of the base and is exposed in the exterior of the vehicle body.

3. The charging socket according to claim 2, wherein the first charging slot and the second charging slot are symmetrically arranged.

4. The charging socket according to claim 1, further comprising:
a rotating shaft, connected to the base, wherein the base is adapted to be connected to the vehicle body by the rotating shaft and rotate relative to the vehicle body between a first angle and a second angle.

5. The charging socket according to claim 4, wherein at the first angle, the first surface of the base and the first charging slot face the interior of the vehicle body; and at the second angle, the first surface of the base and the first charging slot face the exterior of the vehicle body.

6. The charging socket according to claim 4, further comprising:
a driving mechanism, connected to the rotating shaft, wherein the driving mechanism is adapted to drive the rotating shaft to rotate, thereby driving the base to rotate between the first angle and the second angle.

7. The charging socket according to claim 4, wherein a transverse plane perpendicular to the first surface is defined at the base, and the rotating shaft is substantially perpendicular to the transverse plane.

8. An electric vehicle, comprising:
a vehicle body, comprising an interior and an exterior opposite to the interior; and
a charging socket, comprising a base and a first charging slot, wherein the base is connected to the vehicle body and comprises a first surface facing the interior of the vehicle body, and the first charging slot is arranged on the first surface of the base and is exposed in the interior of the vehicle body.

9. The electric vehicle according to claim 8, wherein the base further comprises a second surface facing the exterior of the vehicle body, the charging socket further comprises a second charging slot, and the second charging slot is arranged on the second surface of the base and is exposed in the exterior of the vehicle body.

10. The electric vehicle according to claim 9, wherein the first charging slot and the second charging slot are symmetrically arranged.

11. The electric vehicle according to claim 8, wherein the charging socket further comprises a rotating shaft, the rotating shaft is connected to the base, and the base is adapted to be connected to the vehicle body by the rotating shaft and rotate relative to the vehicle body between a first angle and a second angle.

12. The electric vehicle according to claim 11, wherein at the first angle, the first surface of the base and the first charging slot face the interior of the vehicle body; and at the second angle, the first surface of the base and the first charging slot face the exterior of the vehicle body.

13. The electric vehicle according to claim 11, wherein the charging socket further comprises a driving mechanism connected to the rotating shaft, and the driving mechanism is adapted to drive the rotating shaft to rotate, thereby driving the base to rotate between the first angle and the second angle.

14. The electric vehicle according to claim 11, wherein a transverse plane perpendicular to the first surface is defined at the base, and the rotating shaft is substantially perpendicular to the transverse plane.
